(19) United States
(12) Patent Application Publication
(10) Pub. No.: US 2024/0081296 A1
(43) Pub. Date: Mar. 14, 2024

(54) CENTRAL WALL FOR A BEEHIVE FOR HYPERTHERMIC ERADICATION OF VARROA MITES

(71) Applicant: YOUBEE GMBH, Dobl-Zwaring (AT)

(72) Inventors: David VELIKONJA, Stainz (AT); Robert BREINL, Kalsdorf bei Graz (AT); Hannes SCHEIBER, Kalsdorf bei Graz (AT)

(21) Appl. No.: 17/754,759

(22) PCT Filed: Sep. 24, 2020
(86) PCT No.: PCT/AT2020/060345

§ 371 Date: Apr. 11, 2022

(30) Foreign Application Priority Data
Oct. 17, 2019 (AT) A 60232/2019
Apr. 22, 2020 (AT) A 50343/2020

(51) Int. Cl. A01K 47/06; H05B 3/06; H05B 3/14

(52) U.S. Cl. CPC A01K 47/06; H05B 3/06; H05B 3/145; H05B 2203/013; H05B 2203/02

(57) ABSTRACT

In one example, a heatable centre wall for a beehive is provided for the hyperthermal reduction of varroa and/or for heating honeycombs for maximizing the harvest yields. The centre wall includes a continuous PTC (positive temperature coefficient) heating foil having a non-linear PTC (positive temperature coefficient) effect. As well, the PTC (positive temperature coefficient) heating foil has on at least one of its sides a layer having a comb pattern.

The invention relates to the hyperthermal reduction of varroa by means of heatable centre walls of the bee brood combs and/or for heating honeycombs for maximizing the harvest yields.

In modern beekeeping, there are used wooden frames having wax centre walls to provide the bees with a structured building system for their brood and honeycombs.

Furthermore, it has been known to heat beehives for reducing varroa. From prior art, there may, for example, be mentioned the publication DE 20 2015 107 038 U1. According to this disclosure there are inserted electrically heated centre walls into a honey box. For this purpose, there is integrated into the centre wall a resistance heating element in the form of a rectangular heating coil. The coil is limited to the central area of the centre wall. In order to improve controllability of the heating element, the heating coil is configured as a PTC resistor having a linear PTC effect (positive temperature coefficient), whereby controlling the temperature may be facilitated during the heating phase.

This embodiment has the problem that due to the heating coil this will result in an imbalanced heat entry into areas having low thermal mass and high thermal mass, e.g., honey or brood, whereby so-called hotspots may be developed. This will in particular lead to overheating of smaller areas, whereby the bee brood may be damaged.

Further heated centre walls have been known from the documents DE 102015115103 A1, DE 202015002350 U1 and WO 2015087197 A1. In these documents there are disclosed respective centre walls having continuous heating elements and integrated temperature sensors. These centre walls require a control device, which the heating element control as a function of the actual temperature measured by the temperature sensors will control to bring the centre walls to a target temperature. Such control methods, however, are inert, on the one hand-side, and, on the other side, the control devices need to be weatherproof such that they may be used in the outdoor area of beekeeping.

It is, hence, the task of the invention to provide a heatable centre wall for a beehive, which overcomes the disadvantages of prior art.

This task is solved by a heatable centre wall for a beehive for the hyperthermal reduction of varroa and/or for heating honeycombs for maximizing the harvest yields, wherein the centre wall comprises a continuous PTC heating varnish having a non-linear PTC effect and wherein the centre wall has on at least one side of the PTC heating varnish a layer having a comb pattern. Due to this arrangement, the disadvantages of prior art initially mentioned are being overcome.

The non-linear PTC effect causes the resistance of the PTC heating varnish, starting form a pre-determined temperature, to become so high that a further flow of current through the PTC heating varnish will be largely disrupted and, hence, there will be no further temperature increase. In co-operation with the continuous application of the PTC heating varnish onto the area of the centre wall, this will also result in no hotspots being developed.

Due to the non-linear effect of the PTC heating varnish, this also need not be particularly controlled in order to not exceed a maximum temperature. There also need not be used a control device for correctly heating the centre wall. Furthermore, in or at the centre wall there need not be provided any temperature sensors to provide a feedback for a control device.

The PTC heating varnish is preferably printed onto a substrate separated from the layer or directly onto the layer. The substrate may convey additional rigidity to the PTC heating varnish. Printing the PTC heating varnish onto the layer, however, provides for an easier production.

In the embodiment previously mentioned the heating varnish is carbon varnish, as in this way there may be achieved temperatures using the PTC heating foil, which are in particular suited for the reduction of varroa.

In the embodiments previously mentioned there is further preferably provided a protective varnish on one side of the heating varnish. This will protect against a direct melting of the layer having the comb patterns onto the heating varnish such that the heating vanish will not be damaged.

In order to further increase the structural integrity of the centre wall, there may be arranged between the PTC heating foil and the layers on both sides a stainless steel panel, a plastic plate or a plastic foil. In this way, there may be achieved that the centre wall will have higher rigidity, whereby bending of the centre wall during installation into a small frame will be prevented.

The PTC heating foil may further preferably be configured as a low-voltage element, i.e. the PTC heating foil is operated at a voltage of up to 48 V. In other words, the PTC heating foil will reach a temperature of 40° C. to 42° C. if there is applied thereto a constant voltage of, for example, 12 V, 24 V or 48 V. This will prevent further dangerous situations in the case of a failure of the centre wall, as the contacts of the centre wall will be exposed in the majority of embodiments.

The layer mentioned having the comb pattern may, for example, be a wax layer, as is known from prior art. Due to economic reasons, however, there is preferred that the at least one layer be a plastic wall having a wax coating, wherein the plastic wall includes the comb pattern. It is cheaper to produce this layer than a wax layer, and it may also have better structural features such as, e.g., a higher rigidity.

In the embodiment last mentioned, the plastic wall is preferably made from rePET, i.e. from recycled polyethylene terephthalate (PET), such that the plastic wall may be produced in a more environmentally friendly way.

According to the invention there may be created a device for providing a comb pattern in a beehive, which comprises a centre wall in one of the embodiments previously mentioned and a small frame having a clear spacing the size of the centre wall.

On the one side, the centre wall may be soldered, as known from prior art, to wires of the small frame. It is, however, preferred that the device comprise at least two clamping members, wherein the clamping member fixes the centre wall within the small frame and has at least one clamp, which releasably clamps the small frame or the centre wall.

Due to the solution according to the invention with the at least one clamping member, in which the centre wall or the small frame is clamped in, there is, on the one side, created the possibility to mount a centre wall within a small frame, without having to create a permanent connection for this purpose. In this way, the installation of centre walls is realized more quickly than with embodiments, in which the centre walls are soldered to the wires situated underneath.

As the clamping member may also be removed from the small frame or from the centre wall, respectively, rather quickly, the centre walls may also be removed from the small frame as quickly as they are being installed. It is not necessary to trim wires or to destroy any other elements of the small frame or of the centre wall irrecoverably to remove the centre wall from the small frame.

The clamping member particularly preferably has a first clamp and a second clamp, wherein the first clamp releasably clamps the small frame and wherein the second clamp releasably clamps the centre wall. In this way, also the already existing small frame and the centre walls may be retrofitted, without the clamping members having to be screwed to the small frame or the centre wall.

If there is inserted only one clamping member, then this may fix the centre wall at one side or at one corner at the small frame and may be held merely loosely at the other sides or corners, respectively. If there are inserted only two clamping members, these may hold the centre wall at two opposite sides of the small frame. Preferably, however, the centre wall has a rectangular shape, and the device comprises four clamping members, wherein the clamping members hold the centre wall in the closed position at respectively one corner within the small frame. This will provide an especially stable mounting of the centre wall within the small frame.

In order to further improve the connection between the centre wall and the clamping members, the centre wall has for each clamping member an eyelet or a hole, which respectively one clamping member engages in the closed position. The eyelets or holes, respectively, provide for a form-fit engagement of the clamping members, whereby slipping of the centre wall is prevented. As the centre wall is equipped with an internal PTC heating foil according to the invention, the eyelets furthermore provide simple access to a contact of the PTC heating foil.

The clamping members are preferably made from spring steel or plastic, preferably glass fibre reinforced polyamide (PA). It has been shown that a sufficiently high resistance may be achieved via spring steel or plastic material, respectively, on the one side, such that the clamping members may hold the centre wall within the small frame. On the other side, spring steel or plastic material, respectively, may also be manually bent sufficiently wide apart to remove the centre wall from the small frame. The spring steel or plastic material, respectively, enables an integral production of the clamping members, whereby no separate elements such as tensions springs will be the result. The clamping member, hence, is especially insusceptible to failures.

There may be formed by at least one of the clamping members especially preferably an electrical contact, which generates in the closed position of the clamping element an electric connection to the PTC heating foil of the centre wall. In this way, the PTC heating foil need not have a separate plug or similar, but the electric contact is rather realized simultaneously with the attachment of the centre wall within the small frame.

The electric contact may simply be realized in particular when the small frame comprises at two of its corners respectively one external flap for hooking into the beehive and those two clamping members form contacts with the PTC heating foil, which are situated next to the external flaps of the small frame. The external flaps of the small frame may in this way be used simultaneously for hooking into the beehive and for the expanded contacting.

According to the invention, hence, in the following there may be provided a beehive having a device in one of the embodiments mentioned above. If the electrically contacted clamping members are next to the external flaps, then two ledges may preferably be mounted within the beehive, which ensure the positioning of and the energy distribution onto the small frame.

In a further aspect, the invention relates to a method for producing a heatable centre wall for a beehive for the hyperthermal reduction of varroa and/or for heating honeycombs for maximizing the harvest yields, comprising the steps of:
providing a first layer, preferably a foil,
continuously printing a PTC heating varnish having a non-linear PTC effect onto the first layer,
optionally applying a second layer, preferably a foil, onto the printed PTC heating varnish opposite to the first layer,
providing the first layer and optionally the second layer with a comb pattern.

In a preferred embodiment, before the printing of the PTC heating varnish, printed circuit board tracks are printed onto the first layer, wherein the printed circuit board tracks are preferably composed of silver and wherein the printed circuit board further preferably form a meander-like recess. In this embodiment there is further preferred that the printed circuit board tracks extend along a longitudinal direction of the first layer and the PTC heating varnish is printed in strips onto the first layer, wherein the strips extend along a transverse direction perpendicular to the longitudinal direction mentioned.

There is further preferred that before the application of the second layer there is applied an adhesive layer onto the first layer, however, only onto those locations free of PTC heating varnish. Subsequently, the composite thus produced may be pulled through a roll for further solidifying.

In a preferred embodiment, the application of the comb pattern is realized by applying the first layer and optionally the second layer having molten wax in the comb pattern, wherein the comb pattern is preferably impressed by at least one roll. This provides for an especially good adhesion of the wax on the first layer.

In order to enable the hooking of the centre wall into a small frame, the first layer has in two corner areas a first hole having a first diameter and the second layer has in the same two corner areas a second hole having a second diameter, which is preferably larger than the first diameter for establishing contacts at the printed circuit board tracks.

Advantageous and not limiting embodiments of the invention are in the following explained in greater detail by way of the drawings.

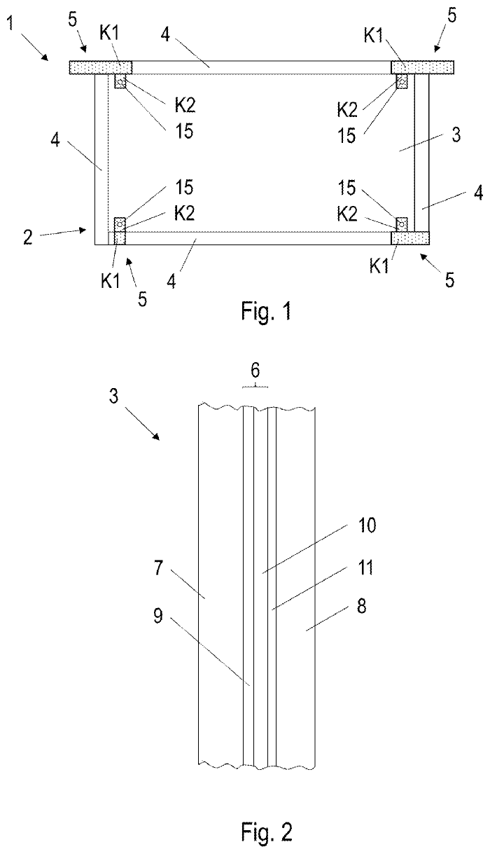

FIG. 1 shows a small frame having a centre wall mounted therein in a front view.

FIG. 2 shows the configuration of the centre wall of FIG. 1.

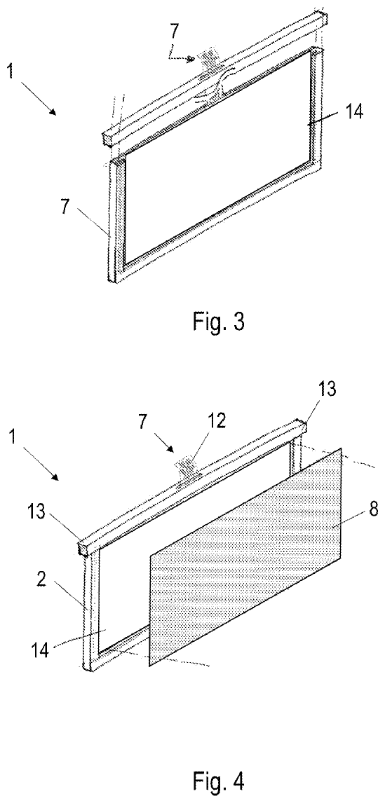

FIG. 3 shows the centre wall without layer having a comb pattern in a perspective view.

FIG. 4 shows the centre wall of FIG. 3, wherein there is applied one layer having a comb pattern onto the centre wall.

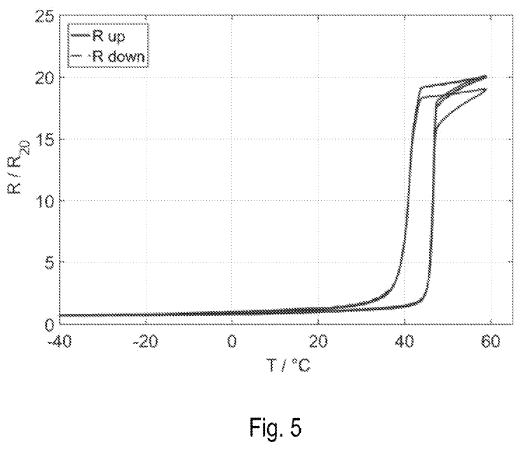

FIG. 5 shows the heating curve of the PTC heating foil of the centre wall according to the invention in a diagram.

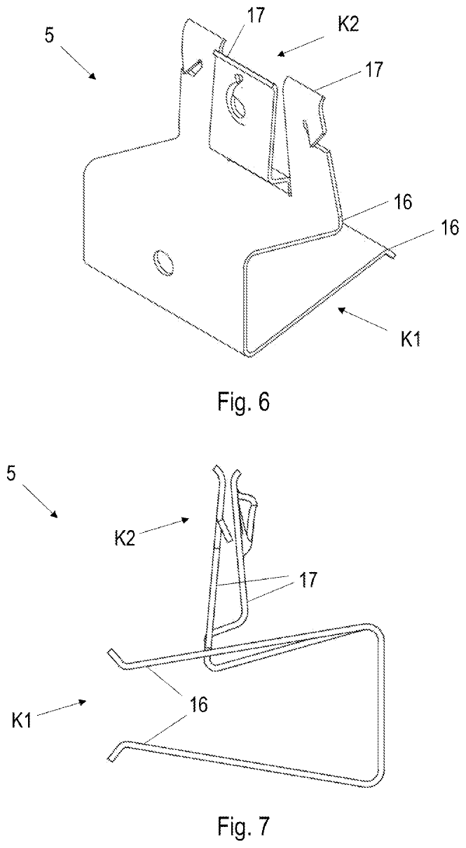

FIG. 6 shows a first variant of a clamping member in a perspective view.

FIG. 7 shows the clamping member of FIG. 6 in a side view.

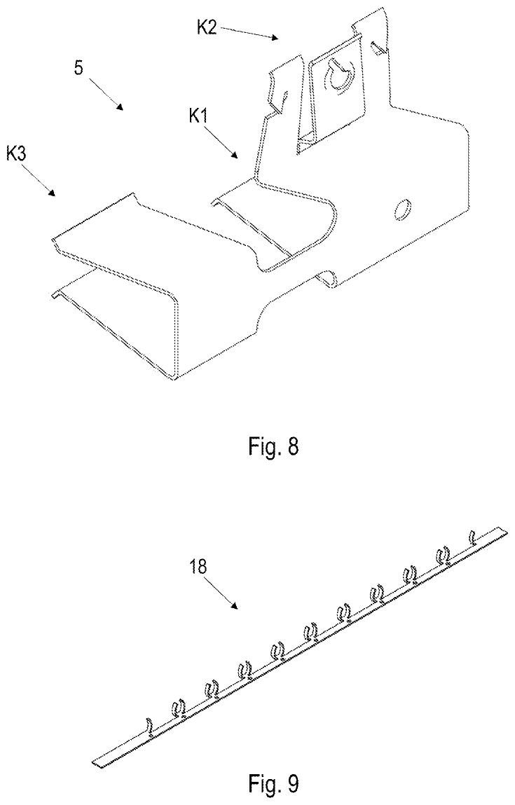

FIG. 8 shows a second variant of a clamping member in a perspective view.

FIG. 9 shows a ledge establishing a contact for a beehive, where several centre walls may be hooked in and may be contacted.

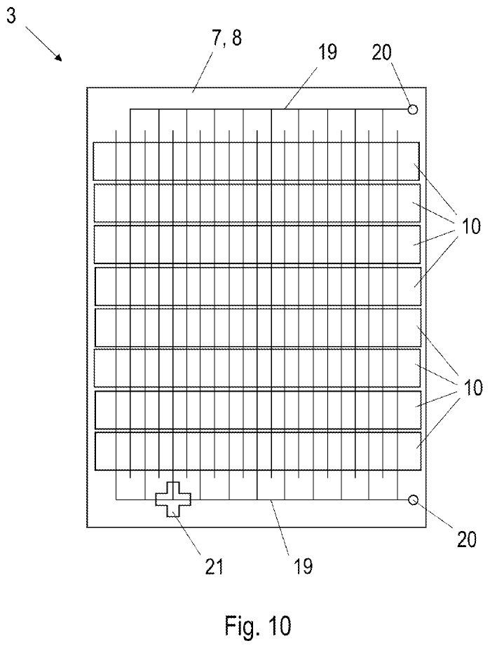

FIG. 10 shows a preferred embodiment of a centre wall according to the invention.

FIG. 1 shows a device 1, which comprises a small frame 2 and a centre wall 3 mounted therein. The small frame 2 is composed of four wooden ledges 4, which are arranged in relation to each other such that there is formed between the wooden ledges 3 _{[M1]}a clear spacing, which is configured to accommodate the centre wall 3. The clear spacing may, for example, have the same or a smaller size than the centre wall 3.

In the depicted embodiment, the centre wall 3 is rectangular. The dimensions of the small frame and, consequently, also of the centre wall 3 are standardized such that the small frame 2 may have a length of 250 mm to 500 mm, and the height of the small frame 100 may be 100 mm to 300 mm. However, the invention is not limited to these dimensions, and the small frame 2 or the centre wall 3, respectively, may even have any other shape than a rectangle and/or the small frame 2 could be composed of any other material than wood, for example a plastic material.

In order fix the centre wall 3 within the small frame 2, the centre wall 3 may also be fixed using clamping members 5 within the small frame, such as described in detail below.

The small frame 2 having a mounted centre wall 3 is configured to be inserted into a beehive not further depicted such that bees may form honeycombs on the centre wall 3. There may be, for example, inserted ten small frames 2 having centres walls 3 mounted therein into a beehive. Such that the bees form uniform honeycombs on the centre wall 3, this is provided with a comb pattern on at least one side. The centre wall 3 is usually provided with a comb pattern on both sides.

The embodiment according to the invention, in which the centre wall 3 has a continuous PTC heating varnish 10 for heating, is described in the following.

The layered configuration of the centre wall 3 having a PTC heating varnish 10 may be realized in various ways. On the one side, the PTC heating varnish 10 may be printed directly onto one of the layers 7, 8. This layer 7, 8 may thus comprise on the one side an imprinted comb pattern and on the other side the PTC heating varnish 10 printed thereon.

As shown in FIG. 2, the centre wall 3 may also comprise a continuous PTC heating foil 6 having a non-linear PTC effect, on both sides of which there may be provided a layer 7, 8 in a comb pattern. The layer 7, 8 may, for example, be a wax layer. In the example of FIG. 3, the centre wall has a configuration from the left to the right of: wax layer 7, carrier foil (substrate) 9, PTC heating varnish 10, protective varnish 11, and wax layer 8.

In combination, the carrier foil 9 and the PTC heating varnish 10 may form the PTC heating foil 6, which is usually realized as a low-voltage element. The heater, hence, is composed of a substrate 9, preferably with etched or printed-on electrodes 12 (see FIG. 3), and an active layer printed thereon, i.e. the PTC heating varnish 10. The PTC heating varnish 10 is preferably a carbon varnish, it may, however, also be any other heating varnish having a non-linear PTC effect and thus not exceeding a pre-determined temperature.

As depicted, the PTC heating foil 6 may be provided on the front surface and on the back surface with the layer 7, 8 mentioned having the comb pattern. Alternatively, the mentioned layer 7, 8 may also be provided only on one side with the PTC heating foil 6. The comb pattern is provided respectively on that side of the layer 7, 8 that faces away from the PTC heating foil 6. The layer 7, 8 could also have the comb pattern on both sides.

The layer 7, 8 may, as described in the example mentioned, also be made in particular from wax. Alternatively, the layer 7, 8 could also be, for example, a plastic wall having a wax coating, wherein the plastic wall has the comb pattern or wherein the comb pattern is formed by the wax coating. For the plastic wall, there may be used in particular rePET, i.e. recycled PET (polyethylene terephthalate).

The protective layer 11 mentioned may be provided to prevent a direct melting of the layer 7, 8 and the PTC heating varnish 10.

FIG. 3, firstly, shows the electric contacts of the PTC heating varnish 10 in one embodiment. Hereby, electrodes 12 extend through the PTC heating foil 6 in order to form an external contact. In the embodiment mentioned above of FIG. 2, the electrodes 12 are situated between the carrier material 9 and the PTC heating varnish 10. The electrodes 12 may extend through a slit within the small frame 2. Alternatively, the electrodes 12 may also extend around the small frame 2. An alternative variant to the electric contact is described below in reference to FIG. 1.

Alternatively or additionally, the PTC heating foil 6 may be connected via wires or flat cables situated within the small frame 2 to the contacts at the external flaps 13 of the small frame 2 or of the beehive. If the small frames 2 are electrically supplied via a contact at the external flaps 13, then there may be mounted two ledges within the beehive, which ensure positioning of and energy distribution onto the individual small frames 2.

The PTC heating foils 6 may be supplied with energy via a voltage supply and/or a control device. Individual brood combs or honeycombs, respectively, may be heated, or all simultaneously.

Secondly, FIG. 3 shows that the PTC heating foil 6 may be bonded with two stainless steel panels 14 (stainless steel panel 14/PTC heating foil 6/stainless steel panel 14) in order to increase the stability of the centre wall 3. Alternatively, for this purpose there could also be inserted plastic plates or plates made from another material.

FIG. 4 shows that the stainless steel panels 14 are each situated between the PTC heating foil 6 and the layer 7, 8 having the comb pattern. In the example depicted, the layer 7, 8 is a wax layer, which has the typical comb pattern. In summary, the PTC heating foil 6 may be mounted, for the purpose of a more homogenous heat distribution and an increased stability, in a “sandwich” configuration, e.g., between the two stainless steel panes 14 mentioned or between plastic plates.

Furthermore, the centre wall 3 may additional comprise a distributing layer made from metal, which contributes to the more efficient heat distribution within the centre wall 3. For example, the PTC heating varnish 10 may be printed directly onto a layer 7 having the comb pattern. The distributing layer may then be arranged between the PTC heating varnish 10 and the second layer 8 having the comb pattern.

The mode of operation of the PTC heating foil 6 is now explained in greater detail by way of FIG. 5. The resistance of the PTC heating foil is indicated on the ordinate of the diagram of FIG. 5 in relation to the resistance of the PTC heating foil at a temperature of 20° C. The temperature of the PTC heating foil 6 is indicated on the x-coordinate.

The heating phase (R up) and the cooling phase (R down) of the heating curves essentially coincide. It is obvious that the PTC heating foils 6 independently adjust at a predetermined temperature, as the resistance at this temperature will escalate.

In practice, there is applied a constant voltage of 12 V or 24 V on the PTC heating varnish 10, for example. A voltage lower than 48, however, is preferred in any case in order to configure the centre wall 3 as a low-voltage element. In the heating phase, the PTC heating varnish 10 will heat, until a predetermined temperature of, for example, 40° C. to 42° C., is reached. At this temperature, the resistance of the PTC heating varnish 10 will escalate, and locally no further current will be received, i.e. the flow of current will be locally stopped. After a certain period of time, the entire PTC heating varnish 10 will be heated to the temperature mentioned such that no further flow of current will be given through the PTC heating varnish 10. Depending on the embodiment, direct current or alternating current may be applied on the PTC heating varnish 10. Thus, it is obvious that the PTC heating varnish 10 need not be controlled in a complicated way in order to reach the desired temperature, but it is rather sufficient to apply a constant voltage on the PTC heating varnish 10.

The predetermined temperature, at which the PTC heating foil 6 will adjust, may be chosen via the material used and the film design. If carbon varnish is used for the PTC heating varnish 10, then the film design may be easily chosen by those skilled in the art in order to select at the predetermined voltage applied a predetermined temperature of, for example, 41° C. The temperature of the PTC heating varnish 10 will be preferably adjust to 40° C. to 42° C. if a voltage of 6 V to 48 V, preferably of 12 V to 24 V, is applied on the PTC heating varnish 10. More generally, there may be chosen a temperature between 40° C. and 42° C. or between 39° C. and 43° C. In this way, there will not be required a control device to control the predetermined temperature of the PTC heating foil 6, which will be achieved by the non-linear PTC effect of the PTC heating foil 6.

The predetermined temperature and/or the heating behaviour of the PTC heating foil 6 is to be adapted to the respective purpose. The heating rate may be achieved during production by adjusting a certain resistance at 20° C. Using the PTC heating varnish 10 having a non-linear PTC effect, the heating phase is usually 5 to 15 minutes. Therefore, the heating phase may be carried out faster than with a PTC resistor having a linear PTC effect, as the PTC heating varnish 10 cannot overheat.

The PTC heating foil 6 is in particular suited for the purpose of varroa reduction. It has been known that varroa mites do not survive at a temperature of about 40° C., while the bee brood remains unaffected at this temperature. If the temperature, however, exceeds about 42° C., also the bee brood will be affected. For the purpose of reducing varroa, the predetermined temperature of the PTC heating foil is adjusted at, for example, 41° C. and/or such that this does not exceed 42° C.

For other purposes, however, the temperature may also be selected to be lower. These include in particular the purpose of reducing honey loss due to melicitose honey, the population increase in spring as well as the increase of flexibility regarding harvest time. For example, there may also be achieved a lower temperature using a control device than the previously mentioned temperature, at which the PTC heating varnish 10 adjust. In an embodiment, the PTC heating varnish 10 may be controlled by means of a control device to 30° C. to 37° C., preferably to 35° C. Only at a later point of time during the year, the PTC heating varnish 10 will be heated to this temperature of 40° C. to 42° C. in order to reduce varroa.

Returning to FIG. 1, there is depicted that the centre wall 3 may be mounted by means of releasable clamping members 5, also called clips, within the small frame 2. Alternatively, the centre wall 3, as known from prior art, may be soldered into the small frame 2. The FIGS. 6 and 7 show a clamping member 5 in detail. This clamping member 5 has two clamps K1 and K2, wherein the first clamp K1 releasably clamps the small frame 2 and the second clamp K2 releasably clamps the centre wall 3. In another embodiment one of the clamps K1, K2 may be replaced by a non-releasable connection or by another connection such as a screw connection.

The clamping members 5 fix the centre wall 3 within the small frame 2, which may be realized, for example, by spring tension, form-fit connection or force-fit connection. The clamping members 5 may be released by application of force, for example, manually, from the centre wall 3 and/or from the small frame 2 such that the centre wall 3 may be removed from the small frame 2. Releasing the clamping member 5 may be realized, for example, by the clamps K1, K2 of the clamping members 5 being expanded against a biasing force. The clamps K1, K2 and/or the clamping member 6 could also include a joint or a hinge, respectively, which will facilitate releasing of the clamping members 5.

The clamping members 5 are realized in spring steel or plastic material, and they are made from a steel sheet or an injection-moulded part, for example. Suitable materials for the clamping members 5 are plastics like glass fibre reinforced polyamide (PA) or stainless steel. The thickness of the spring steel or of the plastic material, respectively, is selected such that manually releasing from the small frame 2 or from the centre wall 3 is being enabled, with, however, applying a sufficiently strong spring force onto the centre wall 3 or onto the small frame 2, respectively, at the same time such that the centre wall 3 is fixed within the small frame 2 if no external force acts on the clamping members 5.

Alternatively or additionally, if spring steel is used, for example, which does not act sufficiently like a spring to fix the centre wall 3, the centre wall 3 may have eyelets 15 or holes, which the clamping member 5 may engage. For this purpose, the clamping member 5 may have a screw or a bolt integral with the clamping member 5. The eyelets 15 are provided with an internal ring to facilitate the establishment of electric contacts. The screw or the bolt, respectively, may be fixed to the other side of the eyelet 15 using a screw nut. Fundamentally, there may also be used a simple hole for the establishment of a contact, wherein this is, however, rather prone to failures.

As shown in the FIGS. 6 and 7, the first clamp K1 has two handles 16, which have a distance at their tips smaller than the thickness of the small frame 2. In particular, this distance is between 8 mm and 12 mm or between 18 and 22 mm such that the majority of the small frames 2 may be clamped. The second clamp K2 has two handles 17, which have a distance at their tips smaller than the thickness of the centre wall 3. The clamps K1, K2 may be bent up by manual handling in order to receive or release, respectively, the small frame 2 or the centre wall 3, respectively. Alternatively, the distances could also be of the same or a larger size than the thickness of the small frame 2 or of the centre wall 3, wherein clamping may here be realized by means of a screw connection through holes in the clamping member 5, the centre wall 3 and/or the small frame 2, for example.

FIG. 8 shows an embodiment of the clamping member 5, which has an extended contact for the external flaps 13. For this purpose, this clamping member 5 has an optional third clamp K3, which might also be replaced by a simple ridge.

As depicted, the centre wall 3 is rectangular, and there are provided in total four clamping members 5, wherein there is provided respectively one clamping member 5 in one corner of the centre wall 3. In other embodiments, however, there could also be provided only two clamping members 5, only three clamping members 5 or more than four clamping members 5. For example, the clamping members 5 could also be attached in the centre of the side surface of the centre wall 3 alternatively or additional to the attachment at corners.

All clamping members 5 of the device 1 could be configured in the same or different way. As visible from FIG. 1, e.g., the left bottom clamping member 5 has a different shape from the right bottom clamping member 5. One or all clamping members 5 may, for example, enclose, such as the left bottom clamping member 5, the small frame 2 only at one of the longitudinal sides, e.g., one of the wooden slats 4, and may be extended not around a corner area of the small frame 2. One or all clamping members 5 may, for example, enclose, such as the right bottom clamping member 5, the small frame 2 at one of the longitudinal sides as well as around the corner area, whereby the stability of the centre wall 3 within the small frame 2 is being further increased.

If the small frame 2 has external flaps 13, by means of which the small frame 2 may be suspended in the beehive, the clamping member 5 may, as shown in FIG. 8, enclose also the external flaps 13 or rest thereon at least, respectively, using the third clamp K3. In FIG. 1, this is shown for the two upper clamping members 5.

Even if clamping members 5 are used, the establishment of electric contacts of the heated centre wall 3 may be realized, one the one side, as described above such that electrodes 12 may extend through the PTC heating foil 6. On the other side, also the clamping members 5 themselves may be used to establish contacts for the heated centre wall 3. For example, the PTC heating foil 6 may be exposed at that location of the centre wall 3, where the contact fixes the centre wall 3. In other words, at this location the centre wall 3 is free from the layer 7, 8 and optionally also free from the protective varnish 11. A particular elegant way to provide a contact is by means of the eyelet 15. In the case of a simple hole through the centre wall 3, the PTC heating foil 6 or the PTC heating varnish 10 is exposed at least in the internal periphery of the hole such that also this solution is possible.

As soon as the clamping members 5 contact the PTC heating foil 6, there may be applied a current supply to the clamping members 5 to heat the PTC heating foil 6. Especially preferably the clamping members 5 establish a contact as far as the external flaps 13 of the small frame 2. In this case, there may be mounted two ledges 18 within the beehive (FIG. 9), which ensure positioning of and energy distribution onto the small frame 2 and, hence, also onto the PTC heating foil 6. If the ledge 18 is integrally made from metal, all centre walls 3 will be simultaneously heated. In alternative embodiments, the ledge may also be provided with isolators to enable the individual heating of individual centre walls 3.

FIG. 10 shows an actual embodiment of the centre wall 3 in detail. For the production of this centre wall, there is provided initially the first layer 7, for example, a PET foil, preferably having a thickness of 100 μm. Then printed circuit board tracks 19 are printed onto the first layer 7, wherein the printed circuit board tracks 19 are preferably composed of silver and wherein the printed circuit board tracks 19 further preferably form a meander-like recess such that the PTC heating varnish 10 may act as a resistance element between the printed circuit board tracks 19. Then the PTC heating varnish 10 is printed in strips onto the first layer 7 or onto the printed circuit board tracks 19, respectively, preferably perpendicularly to these. The distance between the strips favours the heat distribution of the PTC heating varnish 10, wherein the PTC heating varnish 10 might also be printed as a continuous area without distances. The distance between the strips, however, is small enough such that we may continue to speak of a continuous PTC heating varnish 10. “Continuous” is herein understood as being an area of more than 90%, preferably more than 95%, preferably more than 99% of the total area.

Then an adhesive layer is applied onto the first layer 7 or onto the printed circuit board tracks 19, respectively, but only where there is no PTC heating varnish 10. Subsequently, the second layer 8 is applied onto the first layer 7 such that the PTC heating varnish 10, the printed circuit board tracks 19 and the adhesive will be situated in-between the two layers 7, 8 to form a composite. Then the composite is rolled at a predetermined temperature to give the still uncoated centre wall 3 having a thickness of 50 μm to 400 μm, usually 300 μm.

The layers 7, 8 having the PTC heating varnish 10 therein may then be coated with wax to give the comb pattern. For example, pre-fabricated wax plates may be pressed onto the layers 7, 8. The layers 7, 8 could also be immersed into a wax bath and removed therefrom or sprayed with wax. The layers 7, 9 with PTC heating varnish 10 situated therein are preferably pulled through two rolls, wherein there is situated a wax bath within the gusset between the rolls and wax is re-poured onto both sides of the layers 7, 8. In other embodiments the layers 7, 8 could be foils having not two smooth surfaces but rather being provided with a pre-impressed comb pattern on respectively one side.

Optionally there may be included separate holes 20 for hooking the centre wall 3 into the small frame 2. For this purpose, the two layers 7, 8 mentioned may have one or several holes before the production of the composite, which are congruent in the composite. The holes 20 in one layer 7 are preferably larger than in the other layer 8 such that there is enabled a unilateral contact for the printed circuit board tracks 19. It has been shown that it is possible to produce holes 20 already before the coating with wax 4. In this case, the holes 20 are covered by wax after coating, wherein the wax 4, however, may be easily be removed if the centre wall 3 is to be hooked into the small frame 2.

Furthermore, there may be impressed a register mark 21 onto at least one of the layers 7, 8. This makes it possible to exactly determine the position of the PTC heating varnish 10, in particular if there is produced a composite in mass production, which is composed of a foil band having many heating surfaces arranged one after the other. The register mark 21 then provides for the exact separation of the centre walls.

1.-25. (canceled)

26. A heatable centre wall for a beehive for the hyperthermal reduction of varroa and/or for heating honeycombs for maximizing the harvest yields, wherein the centre wall comprises a continuous PTC heating varnish having a non-linear PTC effect, wherein the centre wall has on at least one side of the PTC heating varnish a layer having a comb pattern.

27. A centre wall according to claim 26, wherein the PTC heating varnish is printed onto a substrate separated from the layer or directly onto the layer.

28. A centre wall according to claim 26, wherein the heating varnish is a carbon varnish.

29. A centre wall according to claim 26, wherein a protective varnish is provided on one side of the heating varnish.

30. A centre wall according to claim 26, wherein there is arranged between a PTC heating foil and the layers on both sides a stainless steel panel, a plastic plate or a plastic foil.

31. A centre wall according to claim 26, wherein the at least one layer is a plastic wall having a wax coating, wherein the plastic wall has the comb pattern.

32. A device for providing a comb pattern in a beehive, comprising a centre wall according claim 26 and a small frame having a clear spacing of the size of the centre wall.

33. A device according to claim 32, wherein the PTC heating varnish is connected via wires or flat cables situated within the small frame to contact points at the external flaps of the small frame.

34. A device according to claim 32, wherein the device further comprises at least one clamping member, wherein the clamping member fixes thee centre wall at the small frame and includes at least one clamp (K1, K2), which releasably clamps the small frame or the centre wall.

35. A device according to claim 34, wherein the centre wall has a rectangular shape and the device comprises four clamping members, wherein the clamping members hold the centre wall at respectively one corner within the small frame.

36. A device according to claim 32, wherein the centre wall for every clamping member has an eyelet or a hole, which respectively one clamping member engages in the closed position.

37. A device according to claim 32, wherein at least one of the clamping members forms an electric contact, which generates an electric connection with the PTC heating varnish of the centre wall.

38. A beehive comprising at least one device according to claim 32.

39. A beehive comprising at least one device according to claim 32, wherein there are mounted within the beehive two ledges, which ensure the positioning of and energy distribution onto the small frame.

40. A method for producing a heatable centre wall for a beehive for the hyperthermal reduction of varroa and/or for heating honeycombs for maximizing the harvest yields, comprising the steps of:
providing a first layer,
continuously printing a PTC heating varnish having a non-linear PTC effect onto the first layer,
optionally applying a second layer onto the printed PTC heating varnish opposite to the first layer,
providing the first layer and optionally the second layer with a comb pattern.

41. A method according to claim 40, wherein before the printing of the PTC heating varnish there are printed onto the first layer printed circuit board tracks.

42. A method according to claim 40, wherein the printed circuit board tracks extend along a longitudinal direction of the first layer and the PTC heating varnish is printed strip-like onto the first layer, wherein the strips extend along a transverse direction perpendicular to the longitudinal direction mentioned.

43. A method according to claim 40, wherein before the application of the second layer there is applied an adhesive layer onto the first layer, however, only onto those locations free of PTC heating varnish.

44. A method according to claim 40, wherein the application of the comb pattern is realized by coating the first layer and optionally the second layer with molten wax in a comb pattern.

45. A method according to claim 40, wherein the first layer has in two corner areas a first hole having a first diameter and the second layer has in the same two corner areas a second hole having a second diameter.
